(19) United States
(12) Patent Application Publication
(10) Pub. No.: US 2023/0273440 A1
(43) Pub. Date: Aug. 31, 2023

(54) HEAD-MOUNTED DISPLAY APPARATUS

(71) Applicant: SEIKO EPSON CORPORATION, Tokyo (JP)

(72) Inventor: Yoshihiro YOSHIMURA, MATSUMOTO-SHI (JP)

(73) Assignee: SEIKO EPSON CORPORATION, Tokyo (JP)

(21) Appl. No.: 18/173,802

(22) Filed: Feb. 24, 2023

(30) Foreign Application Priority Data
Feb. 28, 2022 (JP) 2022-029113

(51) Int. Cl. G02B 27/01

(52) U.S. Cl. CPC G02B 27/0172; G02B 27/0149; G02B 2027/0178

(57) ABSTRACT

A head-mounted display apparatus includes a display unit configured to display an image, a support unit configured to support the display unit, and a first extending portion extending from the support unit. At least a portion of the first extending portion is made of an environmental material, and the support unit is made of a material having a higher deflection temperature under load than the environmental material.

The present application is based on, and claims priority from JP Application Serial Number 2022-029113, filed Feb. 28, 2022, the disclosure of which is hereby incorporated by reference herein in its entirety.

### BACKGROUND

### 1. Technical Field

The present disclosure relates to a head-mounted display apparatus.

### 2. Related Art

There has been known a head-mounted display (HMD) that is configured to display an image in a state of being worn on a head portion of a viewer.

For example, JP 2017-111363 A describes a head-mounted display including first and second optical members that cover the front of eyes of a viewer in a see-through manner, a frame portion that supports both optical members, and temples that extend rearward from both left and right ends of the frame portion.

In the head-mounted display as described above, in order to reduce carbon dioxide generated at the time of thermal recycling, the frame portion and the temples may be made of an environmental material. However, since the environmental material has low heat resistance, it is difficult to replace all of the frame portion and the temples with the environmental material.

### SUMMARY

A head-mounted display apparatus according to an aspect of the present disclosure includes,

a display unit configured to display an image,

a support unit configured to support the display unit, and

a first extending portion extending from the support unit, wherein

at least a portion of the first extending portion is made of an environmental material, and

the support unit is made of a material having a higher deflection temperature under load than the environmental material.

### BRIEF DESCRIPTION OF THE DRAWINGS

FIG. 1 is a perspective view schematically illustrating a head-mounted display apparatus according to the present embodiment.

FIG. 2 is a plan view schematically illustrating the head-mounted display apparatus according to the present embodiment.

FIG. 3 is a cross-sectional view schematically illustrating the head-mounted display apparatus according to the present embodiment.

FIG. 4 is a cross-sectional view schematically illustrating the head-mounted display apparatus according to the present embodiment.

FIG. 5 is a functional block diagram illustrating the head-mounted display apparatus according to the present embodiment.

FIG. 6 is a perspective view illustrating the head-mounted display apparatus according to the present embodiment.

FIG. 7 is a table showing the characteristics of resins.

FIG. 8 is a table showing the characteristics of the resins.

FIG. 9 is a cross-sectional view schematically illustrating a head-mounted display apparatus according to a first modification of the present embodiment.

FIG. 10 is a functional block diagram of a head-mounted display apparatus according to a second modification of the present embodiment.

### DESCRIPTION OF EXEMPLARY EMBODIMENTS

Hereinafter, a preferred embodiment of the present disclosure will be described in detail with reference to drawings. Here, the embodiment described hereinafter is not intended to unjustly limit the content of the present disclosure as set forth in the claims. In addition, all of the configurations described hereinafter are not necessarily essential constituent requirements of the present disclosure.

1. Head-Mounted Display Apparatus

### 1.1. Overall Configuration

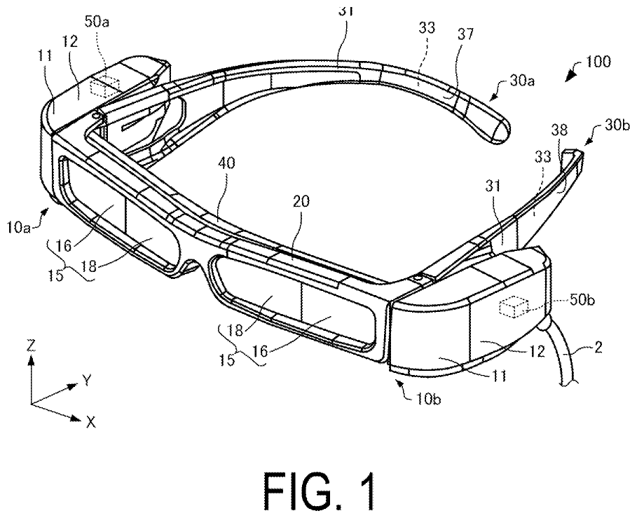

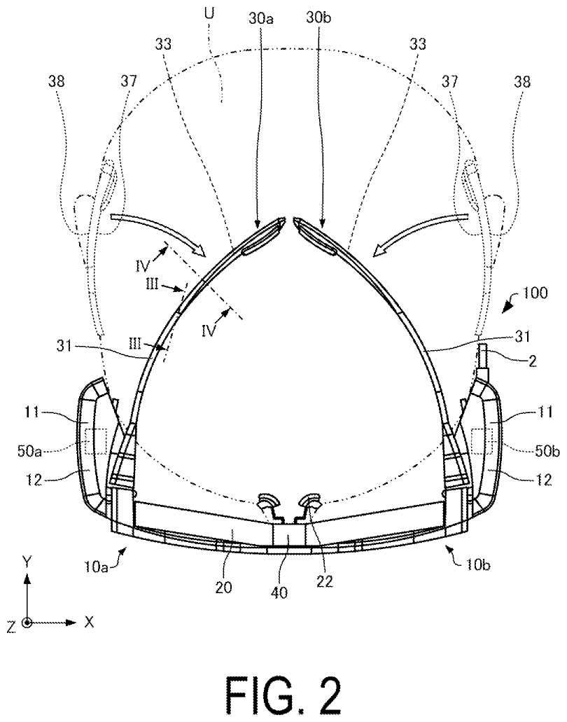

Firstly, the head-mounted display apparatus according to the present embodiment will be described with reference to the drawings. FIG. 1 is a perspective view schematically illustrating a head-mounted display apparatus 100 according to the present embodiment. FIG. 2 is a plan view schematically illustrating the head-mounted display apparatus 100 according to the present disclosure. Here, in FIG. 1 and FIG. 2, an X axis, a Y axis, and a Z axis are illustrated as three axes perpendicular to each other.

As illustrated in FIG. 1 and FIG. 2, the head-mounted display apparatus 100 is a head-mounted display having an appearance of glasses. The head-mounted display apparatus 100 is worn on the head portion of a viewer U. The viewer U is a user who uses the head-mounted display apparatus 100. The head-mounted display apparatus 100 allows the viewer U to visually recognize a virtual image formed by video light and to visually recognize an external image in a see-through manner. The head-mounted display apparatus 100 can also be referred to as a virtual image display apparatus.

The head-mounted display apparatus 100 includes, for example, a first display unit 10a, a second display unit 10b, a support unit 20, a first extending portion 30a, a second extending portion 30b, a detection unit 40, a first control unit 50a, and a second control unit 50b.

The first display unit 10a and the second display unit 10b are configured to display images. To be more specific, the first display unit 10a is configured to display a virtual image for the right eye of the viewer U. The second display unit 10b is configured to display a virtual image for the left eye of the viewer U. In the example illustrated in the drawing, the first display unit 10a is provided on a −X axis direction side of the second display unit 10b. For example, the display units 10a, 10b each include an image forming device 11 and a light guiding device 15.

The image forming device 11 is configured to form image light. For example, the image forming device 11 includes a light emitting device, an optical system such as a projection lens, an external member 12, and the like. The external member 12 accommodates the light emitting device and the projection lens. A material for forming the external member 12 is a resin such as polyamide or polycarbonate, or metal, for example.

The light guiding device 15 covers the front of the eyes of the viewer U. The light guiding device 15 is configured to guide the image light formed by the image forming device 11 and allows the viewer U to visually recognize the external light and the image light in an overlapping manner. Details of the image forming device 11 and the light guiding device 15 will be described later.

The support unit 20 is configured to support the first display unit 10a and the second display unit 10b. For example, the support unit 20 is a frame surrounding the display units 10a, 10b when viewed from the Y axis direction. In the example illustrated in the drawing, the image forming device 11 of the first display unit 10a is attached to an end portion of the support unit 20 on a −X axis direction side. The image forming device 11 of the second display unit 10b is attached to an end portion of the support unit 20 on a +X axis direction side.

A material for forming the support unit 20 is a resin such as polyamide or polycarbonate, or metal, for example. The support unit 20 is formed of a material having a higher deflection temperature under load than the environmental material forming a second portion 33 of the first extending portion 30a. The deflection temperature under load is measured based on “JIS K 7191”, for example. Here, the “material having a deflection temperature under load higher than that of the environmental material” includes a resin having a deflection temperature under load higher than that of the environmental material, and metal that does not reach a predetermined specified deflection described in “JIS K 7191” even if a temperature is increased to a deflection temperature under load of the environmental material when a predetermined load described in “JIS K 7191” is applied. When the material for forming the support unit 20 is a resin, a glass transition temperature of the resin forming the support unit 20 is higher than a glass transition temperature of the environmental material.

As illustrated in FIG. 2, a nose receiving portion 22 is attached to the support unit 20. When the head-mounted display apparatus 100 is worn by the viewer U, the nose receiving portion 22 supports the support unit 20 by coming into contact with the nose of the viewer U.

As illustrated in FIG. 1 and FIG. 2, the first extending portion 30a and the second extending portion 30b extend from the support unit 20. In the example illustrated in the drawing, the first extending portion 30a extends in the +Y axis direction from the end portion of the support unit 20 on the −X axis direction side. The second extension portion 30b extends in the +Y axis direction from the end portion of the support portion on the +X axis direction side. For example, the first extending portion 30a is spaced apart from the display units 10a, 10b. For example, the second extending portion 30b is spaced apart from the display units 10a, 10b.

The first extending portion 30a and the second extending portion 30b are temples that are hooked on ears of the viewer U when the head-mounted display apparatus 100 is worn by the observer U. The head portion of the viewer U wearing the head-mounted display apparatus 100 is positioned between the first extending portion 30a and the second extending portion 30b. The extending portions 30a, 30b will be described in detail later.

Here, although not illustrated in the drawing, the second extending portion 30b may not be provided, and the first extending portion 30a may be formed of a belt that extends from the end portion of the support unit 20 on the −X-axis direction side and reaches the end portion of the support unit 20 on the +X axis direction side.

The detection unit 40 is attached to the support unit 20. In the example illustrated in the drawing, the detection unit 40 is provided at a position facing the glabella of the viewer U when the head-mounted display apparatus 100 is worn by the viewer U. The detection unit 40 is configured to detect that the head-mounted display apparatus 100 is worn by the observer U. When the detection unit 40 is configured to output a detection signal to the control units 50a, 50b when the detection unit 40 detects that the head-mounted display apparatus 100 is worn by the viewer U. The detection unit 40 is a non-proximity sensor, for example.

The position where the detection unit 40 is provided is not particularly limited provided that it is possible to detect that the head-mounted display apparatus 100 is worn by the viewer U. Further, the number of the detection units 40 is not particularly limited. Although not illustrated in the drawing, for example, the head-mounted display apparatus 100 may include two detection units 40, one detection unit 40 may be provided to the first extending portion 30a, and the other detection unit 40 may be provided to the second extending portion 30b.

For example, the first control unit 50a is accommodated in the external member 12 of the first display unit 10a. The first control unit 50a is configured to control a heating unit of the first extending portion 30a. For example, the second control unit 50b is accommodated in the external member 12 of the second display unit 10b. The second control unit 50b is configured to control a heating unit of the second extending portion 30b. For example, the control units 50a, 50b are each configured to include an integrated circuit (IC), a central processing units (CPU), a field programmable gate arrays (FPGA), and the like. Specific processing of the control units 50a, 50b will be described later.

The positions where the control units 30a, 30b are provided are not particularly limited as long as the heating units of the extending portions 50a, 50b can be controlled. Further, although not illustrated in the drawing, the second control unit 50b may not be provided, and both the heating units of the first extending portion 30a and the second extending portion 30b may be controlled by the first control unit 50a. In this case, the first control unit 50a may be configured to output a control signal to the heating units of the extending portions 30a, 30b via a harness 2.

1.2. Extending Portion

As illustrated in FIG. 1 and FIG. 2, the first extending portion 30a and the second extending portion 30b have a symmetrical shape with respect to a virtual plane parallel to a YZ plane. Hereinafter, the first extending portion 30a will be described, and description of the second extending portion 30b is omitted. The description of the first extending portion 30a may be applied to the description of the second extending portion 30b.

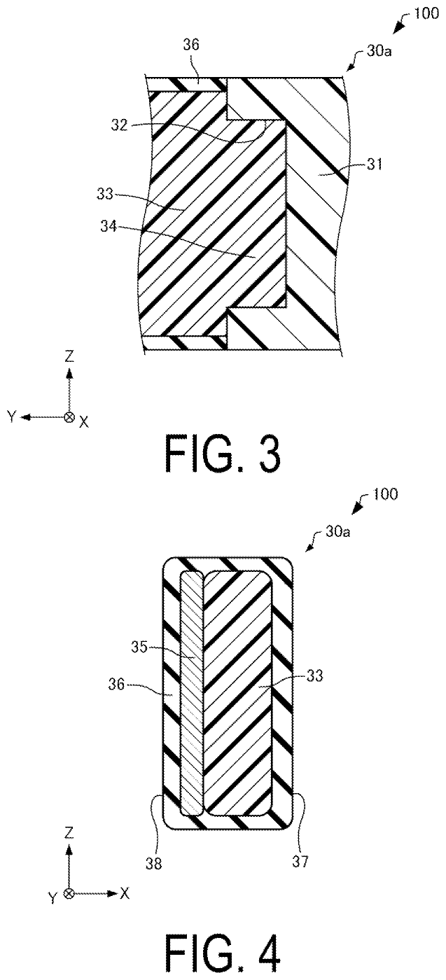

FIG. 3 is a cross-sectional view taken along a line III-III in FIG. 2 and schematically illustrating the first extending portion 30a. FIG. 4 is a cross-sectional view taken along a line IV-IV in FIG. 2 and schematically illustrating the first extending portion 30a.

As illustrated in FIG. 3 and FIG. 4, for example, the first extending portion 30a includes a first portion 31, a second portion 33, a heating unit 35, and a heat insulating portion 36.

The first portion 31 is coupled to the support unit 20. The first portion 31 is configured to move with respect to the support unit 20 using a portion thereof coupled to the support unit 20 as an axis. For example, the first portion 31 is coupled to the support unit 20 via a hinge. As illustrated in FIG. 3, the first portion 31 has a first fitting portion 32 that fits with the second portion 33. In the example illustrated in the drawing, the first fitting portion 32 is a recessed portion.

A material for forming the first portion 31 is a resin such as polyamide or polycarbonate, metal, or the like, for example. For example, the first portion 31 is formed of a material having a higher deflection temperature under load than the environmental material forming the second portion 33. When the material for forming the first portion 31 is a resin, a glass transition temperature of the resin forming the support unit 20 is higher than the glass transition temperature of the environmental material.

The second portion 33 is coupled to the first portion 31. The second portion 33 has a second fitting portion 34 that fits with the first fitting portion 32 of the first portion 31. In the example illustrated the drawing, the second fitting portion 34 is a protruding portion. Here, although not illustrated in the drawing, the first fitting portion 32 may be a protruding portion, and the second fitting portion 34 may be a recessed portion. The first fitting portion 32 and the second fitting portion 34 may be fixed to each other by screwing. For example, the first portion 31 and the second portion 33 are formed by injection molding using two-color molding, insert molding, or the like.

The second portion 33 is made of an environmental material. Accordingly, a part of the first extending portion 30a is made of the environmental material. Here, the first extension portion 30a may be entirely made of the environmental material. The environmental material is organic resources including plant-derived raw materials. As an example of the environmental material, biomass plastics can be named. The environmental material may be a biodegradable plastic or a non-biodegradable plastic.

As examples of the biodegradable plastic for forming the second portion 33, polylactic acid (PLA), polyhydroxyalkanoic acid (PHA) such as polyhydroxybutyric acid (PHB) and 3-hydroxybutyrate-co-3-hydroxyhexanoate polymer (PHBH), polybutylene succinate (PBS), and starch-based polymer, and the like can be named.

As examples of the non-biodegradable plastic for forming the second portion 33, biopolyethylene (bioPE), biopolyethylene terephthalate (bioPET), biourethane (bioPU), biopolycarbonate (bioPC), biopolyamide (bioPA), biounsaturated polyester, a biophenol resin, a bioepoxy resin, aromatic polyester, polyethylene furanoate (PEF), and the like can be named.

As illustrated in FIG. 4, the heating unit 35 is in contact with the second portion 33, for example. For example, the heating unit 35 is in contact with the second portion 33. The heating unit 35 is not in contact with the first portion 31. The second portion 33 is provided on a first surface 37 side of the first extending portion 30a. The heating unit 35 is provided on a second surface 38 side of the first extending portion 30a. A distance between the second portion 33 and the first surface 37 is smaller than a distance between the second portion 33 and the second surface 38. A distance between the heating unit 35 and the first surface 37 is larger than a distance between the heating unit 35 and the second surface 38. The first surface 37 is a surface of the first extending portion 30a that faces the second extending portion 30b when the head-mounted display apparatus 100 is worn by the viewer U. The second surface 38 is a surface on a side opposite to the first surface 37. When the head-mounted display device 100 is worn by the viewer U, the second portion 33 is located between the heating unit 35 and the viewer U. In other words, when the head-mounted display apparatus 100 is worn by the viewer U, the second portion 33 of the first extending portion 30a is in contact with the heating unit 35 on one side that is an opposite side from another side facing the second extending portion 30b.

For example, the heating unit 35 is configured to include a nichrome wire, or the like. The heating unit 35 is a heater that generates heat by being supplied with an electric current. The heating unit 35 is configured to heat the second portion 33. The heating unit 35 is controlled by the first control unit 50a.

The heat insulating portion 36 covers the second portion 33 and the heating unit 35. In the example illustrated in the drawing, the heat insulating portion 36 surrounds the second portion 33 and the heating unit 35. The heat insulating portion 36 is bonded or joined to the second portion 33 and the heating unit 35. For example, a material for forming the heat insulating portion 36 is foamed plastic. In the example illustrated in the drawing, the heat insulating portion 36 forms the first surface 37 and the second surface 38 of the first extending portion 30a.

1.3. Control Unit

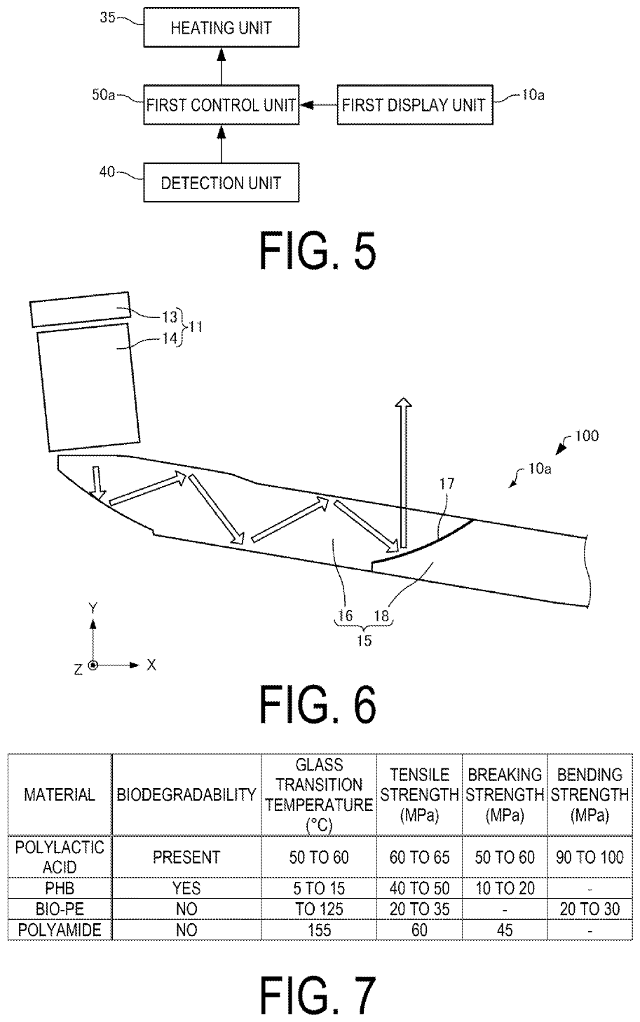

FIG. 5 is a functional block diagram for explaining processing of the first control unit 50a.

As illustrated in FIG. 5, the first control unit 50a is configured to acquire the time during which the first display unit 10a displays an image. The first control unit 50a may be configured to receive and acquire information about the display time of the image from the first display unit 10a, or may be configured to read out and acquire the display time of the image from the first display unit 10a. Further, the first control unit 50a may be configured to acquire the time during which the second display unit 10b displays an image. The first control unit 50a is configured to cause a storage unit not illustrated in the drawing to store the acquired time. For example, the storage unit is constituted of a RAM (random access memory), a ROM (read only memory) or the like.

The first control unit 50a is configured to control the heating unit 35 of the first extending portion 30a based on cumulative time of acquired time. To be specific, the first control unit 50a is configured to cause the heating unit 35 to heat the second portion 33 when the detection unit 40 detects that the head-mounted display 100 is worn and the cumulative time of the acquired time is longer than a predetermined time. The second portion 33 is softened by the heat of the heating unit 35. When the second portion 33 is softened, the first extending portion 30a is brought into a state where the wearing of the head-mounted display apparatus 100 on the viewer U cannot be maintained. To be more specific, when the second portion 33 of the first extending portion 30a is softened, a force of the first extending portion 30b that biases the head portion of the viewer U toward a second extending portion 30b side becomes weak so that the wearing of the head-mounted display apparatus 100 cannot be maintained. As a result, it is possible to notify the viewer U of a fact that the cumulative time of the acquired time is longer than the predetermined time.

Further, when the detection unit 40 no longer detects the wearing of the head-mounted display apparatus 100, the first control unit 50a causes the heating unit 35 to stop the heating of the second portion 33.

For example, the expression of “cumulative time of acquired time” means the display time of the first display unit 10a acquired by the first control unit 50a from a point of time that the viewer U purchased the head-mounted display apparatus 100. For example, the expression of “predetermined time” means the life of the head-mounted display apparatus 100, and is appropriately set by the manufacturer of the head-mounted display apparatus 100.

The second control unit 50b is configured to perform basically the same processing as the first control unit 50a except that the second control unit 50b controls the heating unit 35 of the second extending portion 30b based on cumulative time of acquired time. Accordingly, the detailed description of the second control unit 50b is omitted.

1.4. Image Forming Device and Light Guiding Device

FIG. 6 is a view schematically illustrating the image forming device 11 and the light guiding device 15 of the first display unit 10a.

As illustrated in FIG. 6, the image forming device 11 includes a light emitting device 13 that emits image light, and a projection lens 14 for image formation, for example.

For example, the light emitting device 13 is formed of a self-luminous element such as an organic EL (Electro-Luminescence). The light emitting device 13 emits light according to inputted image information. Alternatively, the light emitting device 13 may include a light source, and a light modulation device that modulates light emitted from the light source according to inputted image information.

The projection lens 14 projects video image light emitted from the light emitting device 13 toward light guiding device 15. As a lens constituting the projection lens 14, a lens having an axially symmetric surface as a lens surface may be used.

For example, the light guiding device 15 is accurately positioned with respect to the projection lens 14 by being fixed to a barrel of the projection lens 14 by screwing. For example, the light guiding device 15 includes a video image light guiding member 16 that guides video image light, and a see-through member 18 for allowing the viewer to visually recognize a video image in a see-through manner.

The video image light emitted from the projection lens 14 is incident on the video image light guiding member 16. The video image light guiding member 16 is a prism that guides the video image light toward the eye of the viewer U. The video image light incident on the video image light guiding member 16 is repeatedly reflected on an inner surface of the video image light guiding member 16 and, thereafter, is reflected on a reflection film 17, and is emitted from the video image light guiding member 16. The video image light emitted from the video image light guiding member 16 reaches the eye of the viewer U. In the example illustrated in the drawing, the reflection film 17 reflects the video image light in the +Y axis direction. For example, the reflection film 17 is formed of a metal film or a dielectric multilayer film. The reflection film 17 may be a half mirror.

The see-through member 18 is disposed adjacent to the video image light guiding member 16. The see-through member 18 is fixed to the video image light guiding member 16. An outer surface of the see-through member 18 is continuous with an outer surface of the video image light guiding member 16. The see-through member 18 allows the viewer U to see external light in a see-through manner. Here, the video image light guiding member 16 also has a function of allowing the viewer U to see external light in a see-through manner in addition to the function of guiding video image light.

1.5. Manner of Operation and Advantageous Effects

The head-mounted display apparatus 100 includes the first display unit 10a that is configured to display an image, the support unit 20 that is configured to support the first display unit 10a, and the first extending portion 30a that extends from the support unit 20. At least a part of the first extending portion 30a is made of the environmental material, and the support unit 20 is made of the material having the deflection temperature under load higher than that of the environmental material.

Accordingly, according to the head-mounted display apparatus 100, it is possible to reduce an amount of carbon dioxide generated at the time of thermal recycling compared to a case where the first extending portion does not contain the environmental material. To be more specific, carbon dioxide discharged when the environmental material is burned is carbon dioxide that plants of the raw material absorbs by the photosynthesis and hence, carbon dioxide generated at the time of thermal recycling can be reduced.

Further, in the head-mounted display apparatus 100, the support unit 20 supporting the first display unit 10a that generates heat is formed of a material having the higher deflection temperature under load than that of the environmental material and hence, it is possible to increase the heat resistance of the support unit 20 compared to a case where the support unit is formed of the environmental material.

As described above, in the head-mounted display apparatus 100, it is possible to increase the heat resistance while reducing an amount of carbon dioxide generated at the time of thermal recycling.

In the head-mounted display apparatus 100, the first extending portion 30a includes the first portion 31 coupled to the support unit 20 and the second portion 33 coupled to the first portion 31, the first portion 31 is formed of the material having the higher deflection temperature under load than that of the environmental material, and the second portion 33 is formed of the environmental material. Accordingly, in the head-mounted display apparatus 100, it is possible to increase the heat resistance of the first portion 31 disposed close to the first display unit 10a compared to a case where the material for forming the first portion is also the environmental material.

In the head-mounted display apparatus 100, the first portion 31 includes the first fitting portion 32 that fits with the second portion 33. Accordingly, in the head-mounted display apparatus 100, the first portion 31 and the second portion 33 can be coupled to each other without using a coupling member such as an adhesive agent, for example.

In the head-mounted display apparatus 100, the first extending portion 30a includes the heating unit 35 that is configured to heat the second portion 33, and the heat insulating portion 36 that covers the heating unit 35 and the second portion 33. Accordingly, in the head-mounted display apparatus 100, it is possible to improve safety by the heat insulating unit 36.

The head-mounted display apparatus 100 includes the second extending portion 30b that extends from the support unit 20, and the first extending portion 30a and the second extending portion 30b are temples. When the head-mounted display apparatus 100 is worn, the second portion 33 of the first extending portion 30a is in contact with the heating unit 35 on one side that is an opposite side from another side facing the second extending portion 30b. Accordingly, in the head-mounted display apparatus 100, it is possible to increase a distance between the viewer U and the heating unit 35 compared to a case where the second portion of the first extending portion is in contact with the heating unit on the one side facing the second extending portion. When the safety of the viewer U is ensured, the heating unit 35 may be provided on a first surface 37 side, and the second portion 33 may be provided on a second surface 38 side.

The head-mounted display apparatus 100 includes the first control unit 50a that is configured to acquire the time during which the first display unit 10a displays an image and to control the heating unit 35 based on the cumulative time of the acquired time. Accordingly, in the head-mounted display apparatus 100, it is possible to automatically drive the heating unit 35 based on the cumulative time of the acquired time.

In the head-mounted display apparatus 100, the detection unit 40 that is configured to detect the wearing of the head-mounted display apparatus 100 is provided, and the first control unit 50a is configured to cause the heating unit 35 to heat the second portion 33 when the wearing of the head-mounted display apparatus 100 is detected by the detection unit 40, and the cumulative time of the acquired time is longer than the predetermined time. Accordingly, in the head-mounted display apparatus 100, by softening the second portion 33 with heat of the heating unit 35, it is possible to bring the first extending portion 30a into a state where the first extending portion 30a cannot maintain the wearing of the head-mounted display appartus 100 on the viewer U. With such a configuration, it is possible to notify the viewer U of a fact that the cumulative time of the acquired time is longer than the predetermined time. As a result, the safety and the quality of the head-mounted display apparatus 100 can be secured.

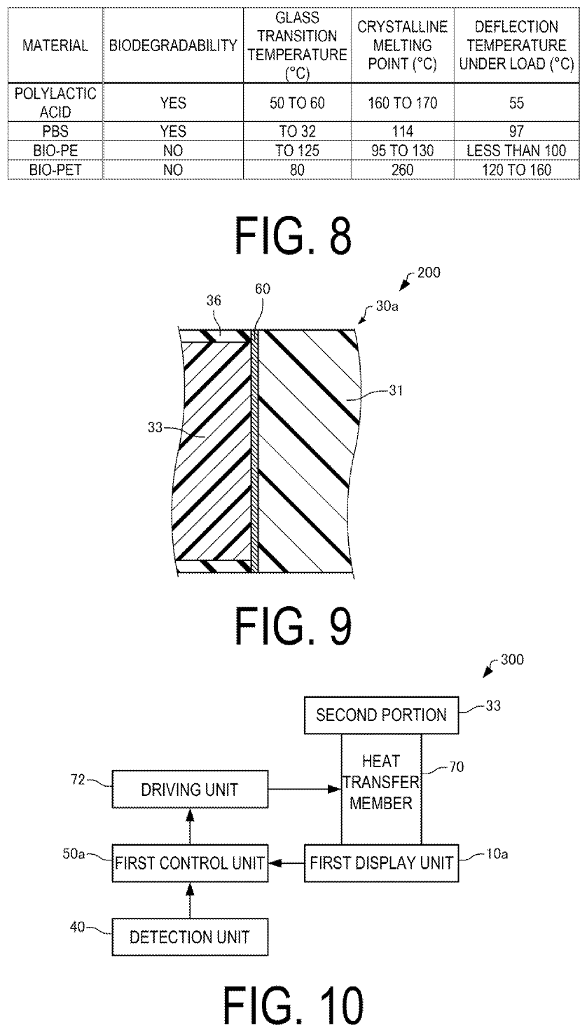

In the head-mounted display apparatus 100, the environmental material is an organic resource containing a plant-derived raw material, and the environmental material is a biodegradable plastic or a non-biodegradable plastic. For example, the environmental material is polylactic acid. The polylactic acid is an amorphous material. Here, FIG. 7 and FIG. 8 are tables showing characteristics of resins. As shown in FIG. 7 and FIG. 8, a glass transition temperature of the polylactic acid is 50° C. or more and 60° C. or less. Accordingly, by using the polylactic acid as the environmental material, it is possible to soften the second portion 33 by heat of the heating unit 35 while ensuring the safety of the viewer U. Further, as shown in FIG. 7, the polylactic acid has the higher tensile strength than PHB and bio-PE. Still further, the polylactic acid has the higher breaking strength than the PHB and polyamide. Further, the polylactic acid has the higher bending strength than the bio-PE.

2. Modification of Head-Mounted Display Apparatus

2.1. First Modification

Next, a head-mounted display apparatus according to a first modification of the present embodiment will be described with reference to drawings. FIG. 9 is a cross-sectional view schematically illustrating a head-mounted display apparatus 200 according to the first modification of the present embodiment.

Hereinafter, in the head-mounted display apparatus 200 according to the first modification of the present embodiment, members having the same functions as those of the constitutional members of the head-mounted display apparatus 100 according to the present embodiment described above are given the same symbols, and their detailed description is omitted. The same also goes for a head-mounted display apparatus according to a second modification of the present embodiment described later.

In the head-mounted display apparatus 100 described above, as illustrated in FIG. 3, the first portion 31 of the first extending portion 30a has the first fitting portion 32. The second portion 33 of the first extending portion 30a has the second fitting portion 34.

On the other hand, in the head-mounted display apparatus 200, a first portion 31 and a second portion 33 of a first extending portion 30a do not have a fitting portion. The first extending portion 30a has a coupling member 60. The second portion 33 is coupled to the first portion 31 via the coupling member 60. For example, the coupling member 60 is an adhesive agent.

In the head-mounted display apparatus 200, the second portion 33 is coupled to the first portion 31 via the coupling member 60. Accordingly, in the head-mounted display apparatus 200, even when the first portion 31 and the second portion 33 do not have a fitting portion, it is possible to couple the first portion 31 and the second portion 33 to each other by the coupling member 60. Here, the first portion 31 and the second portion 33 may be bonded to each other by a known method.

2.2. Second Modification

Next, a head-mounted display apparatus according to a second modification of the present embodiment will be described with reference to drawings. FIG. 10 is a functional block diagram of a head-mounted display apparatus 300 according to the second modification of the present embodiment.

As illustrated in FIG. 10, the head-mounted display apparatus 300 is different from the head-mounted display apparatus 100 described above with respect to a point that the head-mounted display apparatus 300 includes a heat transfer member 70 and a driving unit 72. For example, the head-mounted display apparatus 300 does not include the heating unit 35.

For example, a material for forming the heat transfer member 70 is graphite, copper, aluminum, or the like. A shape of the heat transfer member 70 is not particularly limited. The heat transfer member 70 may be formed of a copper wire. The heat transfer member 70 is configured to couple the first display unit 10a and the second portion 33 of the first extending portion 30a to each other. The heat transfer member 70 is configured to transfer heat generated in the first display unit 10a to the second portion 33 by coupling the first display unit 10a and the second portion 33 to each other. For example, the heat transfer member 70 is configured to transfer heat of a light emitting device 13 to the second portion 33 by coupling the light emitting device 13 of the first display unit 10a and the second portion 33 to each other.

The driving unit 72 is configured to deform the heat transfer member 70 by being driven. For example, the driving unit 72 includes a motor. The driving unit 72 is controlled by a first control unit 50a.

Heat transfer member 70 may be coupled to a light emitting device 13, and may be configured to couple the light emitting device 13 and the second portion 33 to each other by being coupled to the second portion 33 due to driving of the driving unit 72. Alternatively, the heat transfer member 70 may be coupled to the second portion 33, and may be configured to couple the light emitting device 13 and the second portion 33 to each other by being coupled to the light emitting device 13 due to driving of the driving unit. Alternatively, the heat transfer member 70 may include a first coupling portion coupled to the light emitting device 13 and a second coupling portion coupled to the second portion 33, and may be configured to couple the light emitting device 13 and the second portion 33 to each other since the first coupling portion and the second coupling portion are coupled to each other due to driving of the driving unit 72.

The first control unit 50a is configured to change a shape of the heat transfer member 70 by driving the driving unit 72 when the wearing of the head-mounted display apparatus 100 is detected by the detection unit 40 and the cumulative time of the acquired time is longer than the predetermined time thus coupling the light emitting device 13 and the second portion 33 to each other by the heat transfer member 70. Accordingly, heat generated by the light emitting device 13 can be transferred to the second portion 33 via the heat transfer member 70. The second portion 33 is softened by the heat. When the second portion 33 is softened, the first extending portion 30a is brought into a state where the wearing of the head-mounted display apparatus 100 on the viewer U cannot be maintained. With such a configuration, it is possible to notify the viewer U of a fact that the cumulative time of the acquired time is longer than the predetermined time.

Here, although an example where the heat transfer member 70 is deformed by driving of the driving unit 72 has been described heretofore, the heat transfer member 70 may not be deformed as long as the heat transfer member 70 is configured to couple the light emitting device 13 and the second portion 33 to each other by driving of the driving unit 72. For example, the first control unit 50a may be configured to couple the light emitting device 13 and the second portion 33 to each other by the heat transfer member 70 by moving the heat transfer member 70 by driving the driving unit 72.

The head mounted display apparatus 300 includes the heat transfer member 70, and the heat transfer member 70 is configured to transfer heat generated in the first display unit 10a to the second portion 33 by coupling the first display unit 10a and the second portion 33 to each other. Accordingly, in the head-mounted display apparatus 300, the second portion 33 can be softened by the heat of the first display unit 10a.

The above-described embodiments and modifications are merely examples, and the present disclosure is not limited thereto. For example, the respective embodiments and the respective modifications may also be suitably combined with each other.

The present disclosure includes substantially the same configuration as the configuration described in the embodiment, for example, a configuration having the same function, method, and result or a configuration having the same object and advantageous effect. Further, the present disclosure includes a configuration in which a non-essential part of the configuration described in the embodiment is replaced. Still further, the present disclosure includes a configuration that exhibits the same manner of operation and advantageous effects as the configuration described in the embodiment or a configuration that can achieve the same object. Further, the present disclosure includes a configuration in which a known technique is added to the configuration described in the embodiment.

The following contents are derived from the above-described embodiments and modifications.

A head-mounted display apparatus according to an aspect of the present disclosure includes,

a display unit configured to display an image,

a support unit configured to support the display unit, and

a first extending portion extending from the support unit, wherein

at least a portion of the first extending portion is made of an environmental material, and

the support unit is made of a material having a higher deflection temperature under load than the environmental material.

According to the head-mounted display apparatus, it is possible to increase heat resistance while reducing an amount of carbon dioxide generated at the time of thermal recycling.

In the head-mounted display apparatus according to an aspect of the present disclosure,

the first extending portion may include

a first portion coupled to the support portion, and

a second portion coupled to the first portion, wherein

the first portion may be made of a material having the higher deflection temperature under load than that of the environmental material, and

the second portion may be made of the environmental material.

According to the head-mounted display apparatus, it is possible to increase the heat resistance of the first portion.

In the head-mounted display apparatus according to an aspect of the present disclosure,

the first portion may include a fitting portion that fits with the second portion.

According to the head-mounted display apparatus, the first portion and the second portion can be coupled to each other without using a coupling member.

In the head-mounted display apparatus according to an aspect of the present disclosure,

the second portion may be coupled to the first portion via the coupling member.

According to the head-mounted display apparatus, even when the first portion and the second portion do not have the fitting portion, it is possible to couple the first portion and the second portion to each other by the coupling member.

In the head-mounted display apparatus according to an aspect of the present disclosure,

the head-mounted display apparatus may include a heat transfer member configured to transfer heat generated by the display unit to the second portion.

According to the head-mounted display apparatus, the second portion can be softened by the heat of the display unit.

In the head-mounted display apparatus according to an aspect of the present disclosure,

the first extending portion may include

a heating unit that is configured to heat the second portion, and

a heat insulating portion covering the heating unit and the second portion.

According to the head-mounted display apparatus, it is possible to improve safety by the heat insulating portion.

In the head-mounted display apparatus according to an aspect of the present disclosure,

the head-mounted display apparatus may include a second extending portion extending from the support unit,

the first extending portion and the second extending portion may be temples, and

the second portion of the first extending portion may be in contact with the heating unit on a side opposite to one side facing the second extending portion when the head-mounted display apparatus is worn.

According to the head-mounted display apparatus, it is possible to increase a distance between a viewer of the head-mounted display apparatus and the heating unit.

In the head-mounted display apparatus according to an aspect of the present disclosure,

the head-mounted display apparatus may include a control unit that is configured to acquire the time during which the display unit displays an image and to control the heating unit based on the cumulative time of the acquired time.

According to the head-mounted display apparatus, it is possible to automatically drive the heating unit based on the cumulative time of the acquired time.

In the head-mounted display apparatus according to an aspect of the present disclosure,

the head-mounted display apparatus may include a detection unit that is configured to detect that the head-mounted display apparatus is worn, and

the control unit may be configured to cause the heating unit to heat the second portion when the wearing of the head-mounted display apparatus is detected by the detection unit, and the cumulative time of the acquired time is longer than a predetermined time.

According to the head-mounted display apparatus, by softening the second portion with heat of the heating unit, it is possible to bring the first extending portion into a state where the first extending portion cannot maintain the wearing of the head-mounted display apparatus on the viewer.

In the head-mounted display apparatus according to an aspect of the present disclosure,

the environmental material may be an organic resource containing a plant-derived raw material, and

the environmental material may be a biodegradable plastic or a non-biodegradable plastic.

According to the head mounted display device, for example, it is possible to soften the second portion by the heat of the heating unit while securing the safety of the viewer wearing the head-mounted display apparatus.

What is claimed is:

1. A head-mounted display apparatus, comprising:
a display unit configured to display an image;
a support unit configured to support the display unit; and
a first extending portion extending from the support unit, wherein
at least a portion of the first extending portion is made of an environmental material, and
the support unit is made of a material having a higher deflection temperature under load than the environmental material.

2. The head-mounted display apparatus according to claim 1 wherein,
the first extending portion includes:
a first portion coupled to the support portion; and
a second portion coupled to the first portion, wherein
the first portion is made of a material having a higher deflection temperature under load than the environmental material, and
the second portion is made of the environmental material.

3. The head-mounted display device according to claim 2, wherein
the first portion includes a fitting portion that fits with the second portion.

4. The head-mounted display apparatus according to claim 2, wherein
the second portion is coupled to the first portion via a coupling member.

5. The head-mounted display apparatus according to claim 2, comprising a heat transfer member configured to transfer, to the second portion, heat generated by the display unit.

6. The head-mounted display apparatus according to claim 2 wherein,
the first extending portion includes:
a heating unit configured to heat the second portion; and
a heat insulating portion covering the heating unit and the second portion.

7. The head-mounted display apparatus according to claim 6, comprising a second extending portion extending from the support unit, wherein
the first extending portion and the second extending portion are temples, and
when the head-mounted display apparatus is worn, the second portion of the first extending portion is in contact with the heating unit on one side that is an opposite side from another side facing the second extending portion.

8. The head-mounted display apparatus according to claim 6, comprising a control unit configured to acquire a time during which the display unit displays an image and to control the heating unit based on a cumulative time of the acquired time.

9. The head-mounted display apparatus according to claim 8, comprising a detection unit configured to detect that the head-mounted display apparatus is worn, wherein
the control unit causes the heating unit to heat the second portion, when the detection unit detects that the head-mounted display apparatus is worn, and the cumulative time of the acquired time is longer than a predetermined time.

10. The head-mounted display apparatus according to claim 5, wherein
the environmental material is an organic resource containing a plant-derived raw material, and
the environmental material is a biodegradable plastic or a non-biodegradable plastic.
